(19) United States
(12) Patent Application Publication
(10) Pub. No.: US 2008/0143430 A1
(43) Pub. Date: Jun. 19, 2008

(54) OUTPUT SIGNAL DRIVING CIRCUIT AND METHOD OF DRIVING OUTPUT SIGNAL

(76) Inventor: Yi-Lin Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/956,310

(22) Filed: Dec. 13, 2007

(30) Foreign Application Priority Data
Dec. 15, 2006 (TW) 095147102

(51) Int. Cl. G05F 1/10

(52) U.S. Cl. 327/543

(57) ABSTRACT

An output signal driving circuit is provided. The output signal driving circuit includes a first switch, a second switch, a third switch, and a fourth switch. The first switch is for selectively conducting a first supply voltage with a first terminal according to a first control signal. The second switch is for selectively conducting a second supply voltage with a second terminal according to a second control signal. The third switch is for selectively conducting the first terminal with an output terminal of the output signal driving circuit according to a third reference voltage. The fourth switch is for selectively conducting the second terminal with the output terminal according to a fourth reference voltage. The voltage level of both the third and the fourth reference voltages are between voltage levels of the first and the second supply voltages.

### BACKGROUND OF THE INVENTION

1. Field of the Invention

The present invention relates to a circuit for outputting signals, and a method thereof, and more particularly, to an output signal driving circuit applied in a memory (e.g. a DDR memory) and a method thereof.

2. Description of the Prior Art

A memory bandwidth always dominates the processing performance of a computer system. Therefore, in order to develop a new memory specification, current path technique is becoming an important topic in semiconductor manufacturing. For example, the memory transmission specification of a double data rate memory (DDR Memory) has developed from DDR1, DDR11 to the latest DDR111. However, manufacturers of application specific integrated circuits (ASIC) are unable to provide the latest manufacturing process for clients when the accessing rate of the memory increases. According to the specification validated by JDEC, the DDR1 memory should follow the SSTL25 specification, i.e. the voltage at the input/output (IO) ports must be 2.5V; the DDR11 memory should follow the SSTL18 specification, i.e. the voltage at the input/output (IO) ports must be 1.8V, and the DDR111 memory should follow the SSTL15 specification, i.e. the voltage at the input/output (IO) ports must be 1.5V. However, the ASIC manufacturer only provides two types of manufacturing processes (i.e., low voltage element and high voltage element) for the clients. Therefore, when designing the I/O pads of the memory controller, the high voltage transistor (i.e. 3.3V) is designed to operate under 2.5V (i.e. DDR1 memory), or designed to operate under 1.8V (i.e. DDR11 memory). Please refer to FIG. 1. FIG. 1 is a diagram illustrating the current-voltage transfer characteristic of the conventional 3.3V transistor. When the 3.3V transistor operates under the voltage of 1.8V (i.e. DDR11), the operating current I₂ is smaller than the operating current I₁, wherein the operating current I₂ is the current of the 3.3V transistor operating under 1.8V and the operating current I₁ is the current of the 3.3V transistor operating under 3.3V. However, the driving current may not be enough to obtain the required charging time of the DDR11 memory at the I/O pads, therefore the width of the transistor should be enlarged to increase the driving current and the area of the I/O pads should be reduced at the same time. Accordingly the cost of the chip is increased. Similarly, when the 3.3V transistor operates under 1.5V (i.e. DDR111), the operating current I₃ is smaller than the operating current I₁, wherein the operating current I₃ is the current of the 3.3V transistor operating under 1.5V and the operating current I₁ is the current of the 3.3V transistor operating under 3.3V. It can be seen that the operating current I₃ is smaller than the operating current I₂, thus the required chip area will be larger than the chip area that operates under 1.8V.

### SUMMARY OF THE INVENTION

Therefore, one of the objectives of the present invention is to provide an output signal driving circuit applied in a memory (e.g. a DDR memory) and a method thereof, which is capable of reducing the area of an input/output pad to solve the above-mentioned problem.

According to an embodiment of the present invention, an output signal driving circuit is provided. The output driving circuit comprises a first switch, a second switch, a third switch, and a fourth switch. The first switch has a terminal coupled to a first supply voltage, and has another terminal coupled to a first terminal, wherein the conductivity of the first switch is controlled by a first control signal for selectively conducting the first supply voltage to the first terminal. The second switch has a terminal coupled to a second supply voltage, and has another terminal coupled to a second terminal, wherein the conductivity of the second switch is controlled by a second control signal for selectively conducting the second supply voltage to the second terminal. The third switch has a terminal coupled to the first terminal, and has another terminal coupled to an output terminal, wherein the conductivity of the third switch is controlled by a third reference voltage for selectively conducting the first terminal to the output terminal. The fourth switch has a terminal coupled to the output terminal, and has another terminal coupled to the second terminal, wherein the conductivity of the fourth switch is controlled by a fourth reference voltage for selectively conducting the output terminal to the second terminal; wherein voltage levels of the third reference voltage and the fourth reference voltage are between the voltage level of the first supply voltage and the voltage level of the second supply voltage.

According to a second embodiment of the present invention, an output signal driving method is provided. The output signal driving method comprises the steps of: selectively conducting the first supply voltage to the first terminal according to a first control signal; selectively conducting the second supply voltage to the second terminal according to a second control signal; selectively conducting the first terminal to the output terminal according to a third reference voltage; and selectively conducting the output terminal to the second terminal according to a fourth reference voltage; wherein voltage levels of the third reference voltage and the fourth reference voltage are between the voltage level of the first supply voltage and the voltage level of the second supply voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a current-voltage transfer characteristic diagram of a prior art 3.3V transistor.

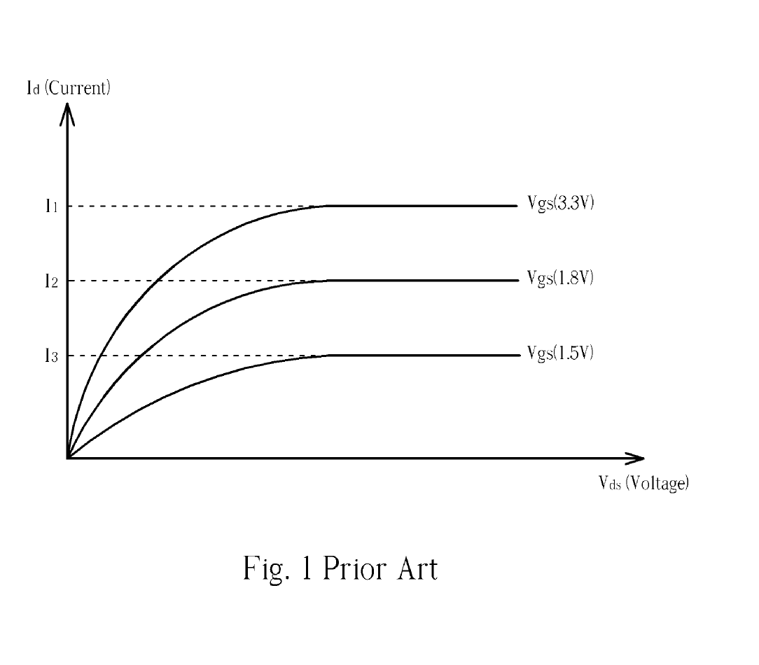

FIG. 2 is a diagram illustrating an output signal driving circuit according to an embodiment of the present invention.

FIG. 3 is a current-voltage transfer characteristic diagram of the P-type field effect transistors as shown in FIG. 2.

FIG. 4 is a current-voltage transfer characteristic diagram of the N-type field effect transistors as shown in FIG. 2.

FIG. 5 is a flow chart illustrating an output signal driving method according to a second embodiment of the present invention.

### DETAILED DESCRIPTION

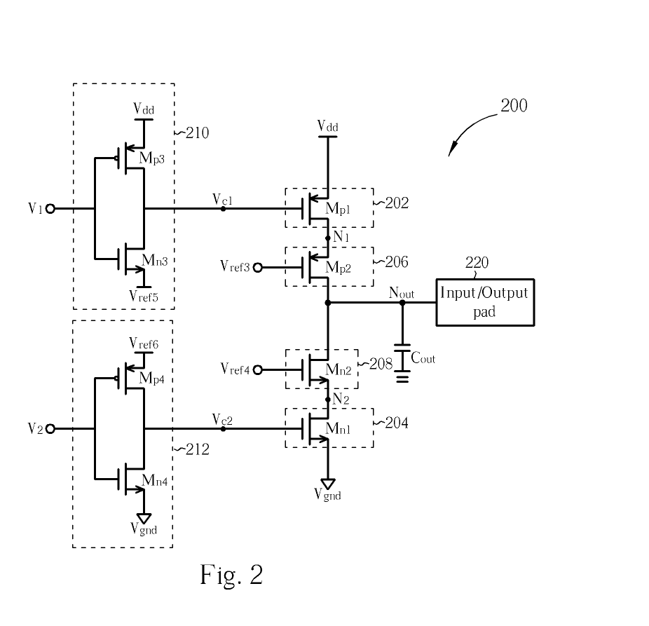

Please refer to FIG. 2. FIG. 2 is a diagram illustrating an output signal driving circuit 200 according to an embodiment of the present invention. The output signal driving circuit 200 includes a first switch 202, a second switch 204, a third switch 206, a fourth switch 208, a first pre-drive circuit 210, and a second pre-drive circuit 212. In this embodiment of the present invention, the first switch 202 has a terminal coupled to a first supply voltage V_{dd}, and has another terminal coupled to a first terminal N₁, wherein the conductivity of the first switch 202 is controlled by a first control signal V_{c1} for selectively conducting the first supply voltage V_{dd} to the first terminal N₁. The second switch 204 has a terminal coupled to a second supply voltage V_{gnd}, and has another terminal coupled to a second terminal N₂, wherein the conductivity of the second switch 204 is controlled by a second control signal V_{c2} for selectively conducting the second supply voltage V_{gnd} to the second terminal N₂. The third switch 206 has a terminal coupled to the first terminal N₁, and has another terminal coupled to an output terminal Nₒᵤₜ of the output signal driving circuit 200, wherein the conductivity of the third switch 206 is controlled by a third reference voltage V_{ref3} for selectively conducting the first terminal N₁ to the output terminal Nₒᵤₜ. The fourth switch 208 has a terminal coupled to the second terminal N₂, and has another terminal coupled to the output terminal Nₒᵤₜ of the output signal driving circuit 200, wherein the conductivity of the fourth switch 208 is controlled by a fourth reference voltage V_{ref4} for selectively conducting the second terminal N₂ to the output terminal Nₒᵤₜ. The first pre-drive circuit 210 is coupled to the first switch 202 and receives the first input signal V₁ for selecting one of the first supply voltage V_{dd} and a fifth reference voltage V_{ref5} to be the first control signal V_{c1} according to the first input signal V₁. In other words, the first pre-drive circuit 210 is a level shifter for setting the voltage level of the first control signal V_{c1} to be the first supply voltage V_{dd} or the fifth reference voltage V_{ref5} according to the first input signal V₁. The second pre-drive circuit 212 is coupled to the second switch 204 and receives the second input signal V₂ for selecting one of the second supply voltage V_{gnd} and a sixth reference voltage V_{ref6} to be the second control signal V_{c2} according to the second input signal V₂. Similarly, the second pre-drive circuit 212 is a level shifter for setting the voltage level of the second control signal V_{c2} to be the second supply voltage V_{gnd} or the sixth reference voltage V_{ref6} according to the second input signal V₂. The output terminal Nₒᵤₜ of the output signal driving circuit 200 is further coupled to an input/output (I/O) pad 220, which causes an equivalent capacitor Cₒᵤₜ at the output terminal Nₒᵤₜ.

Please note that, according to an embodiment of the present invention, the first switch 202 is implemented by a P-type field effect transistor Mₚ₁ that has an aspect ratio of (W/L)₁, the second switch 204 is implemented by an N-type field effect transistor Mₙ₁ that has an aspect ratio of (W/L)₂, the third switch 206 is implemented by a P-type field effect transistor Mₚ₂ that has an aspect ratio of (W/L)₃, the fourth switch 208 is implemented by a P-type field effect transistor Mₚ₄ that has an aspect ratio of (W/L)₄, the first pre-drive circuit 210 is implemented by an inverter, which comprises a P-type field effect transistor Mₚ₃ and an N-type field effect transistor Mₙ₃), and the second pre-drive circuit 212 is implemented by an inverter, which comprises a P-type field effect transistor Mₚ₄ and an N-type field effect transistor Mₙ₄). However, those skilled in this art will easily understand that the first switch 202, the second switch 204, the third switch 206, the fourth switch 208, the first pre-drive circuit 210, and the second pre-drive circuit 212 can be replaced by other electronic elements having the same function, thus the detailed description of the electronic elements is omitted here for brevity.

Furthermore, according to this embodiment of the present invention, the P-type field effect transistors Mp1, Mp2 and the N-type field effect transistors Mn1, Mn2 are low voltage devices, and in order to operate the P-type field effect transistors Mp1, Mp2 and the N-type field effect transistors Mn1, Mn2 normally, the voltage levels of the above-mentioned third, fourth, fifth, sixth reference voltages V_{ref3}˜V_{ref6} are set between the voltage level of the first supply voltage V_{dd} and the voltage level of the second supply voltage V_{gnd}. As, in the advanced manufacturing process, the voltage level of the first supply voltage V_{dd} gets lower, the above-mentioned low voltage device that operates under 1.3V is just an example, and not a limitation of the present invention.

Furthermore, in order to describe the operation of the present invention more clearly, the third, fourth, fifth, sixth reference voltages correspond to the same voltage level V_{ref}, wherein V_{ref} is equal to V_{dd}/2, and V_{dd} is 2.5V (i.e. the output terminal Nₒᵤₜ coupled to the DDR1 memory) or 1.8V (i.e. the output terminal Nₒᵤₜ coupled to the DDR11 memory) or 1.5V (i.e. the output terminal Nₒᵤₜ coupled to the DDR111 memory), and V_{gnd} is 0V. Please note that the voltage levels of 2.5V, 1.8V, and 1.5V are just given as examples of this embodiment, and are not limitations of the present invention. In other words, those skilled in this art will readily understand that other voltage levels having the same result as this embodiment also belong to the scope of the present invention.

When the output signal driving circuit 200 is applied in the DDR111 memory for accessing the DDR111 memory, under the predetermined status, V_{dd} is 1.5V (i.e. V_{ref} is 0.75V), the output voltage Vₒᵤₜ of the output terminal Nₒᵤₜ is 0V, the first input signal V₁ is 0V, and the second input signal V₂ is 0V. When the first input signal V₁ and the second input signal V₂ switch to the high voltage level of 1.5V at the same time, the inverter of the first pre-drive circuit 210 and the inverter of the second pre-drive circuit 212 output the first control signal V_{c1} of 0.75V and the second control signal V_{c2} of 0V. As the gate-source voltage drop of the P-type field effect transistor Mₚ₁ is 0.75V (i.e. larger than the threshold voltage Vth), the P-type field effect transistor Mₚ₁ will be turned on to consequently turn on the P-type field effect transistor Mₚ₂, then the first supply voltage V_{dd} charges the equivalent capacitor Cₒᵤₜ at the output terminal Nₒᵤₜ. The second control signal V_{c2} turns off the N-type field effect transistor Mₙ₁, therefore the output voltage Vₒᵤₜ will be charged to the high voltage level 1.5V.

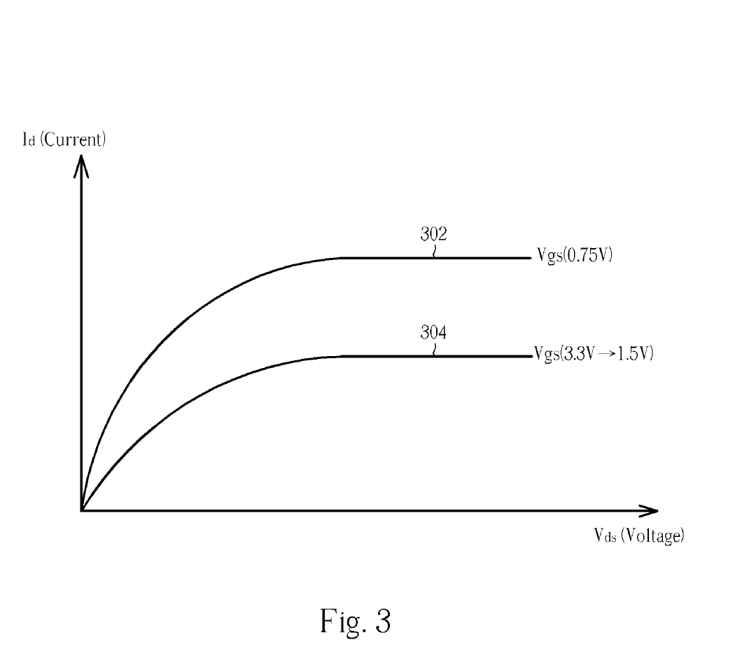

Please refer to FIG. 3. FIG. 3 is a current-voltage transfer characteristic diagram of the P-type field effect transistors Mₚ₁, Mₚ₂ as shown in FIG. 2. When the output voltage Vₒᵤₜ is increased from 0V to 10.5V, the currents of the low voltage P-type field effect transistor Mₚ₁, Mₚ₂ are larger than the currents of the conventional high voltage (3.3V) P-type field effect transistors that operate under 1.5V, as shown in the curve 304 in FIG. 3. In other words, the current charging efficiency of the P-type field effect transistor Mₚ₁, Mₚ₂ is better than the prior art method.

Furthermore, if the output voltage Vₒᵤₜ of the output terminal Nₒᵤₜ switches to 0V, the P-type field effect transistor Mₚ₁, Mₚ₂ will be turned off, and the N-type field effect transistor Mₙ₁, Mₙ₂ will be turned on for discharging the output capacitor Cₒᵤₜ to decrease the output voltage Vₒᵤₜ. Therefore, the first input signal V₁ and the second input signal V₂ are switched to the low voltage level 0V at the same time, and the inverter of the first pre-drive circuit 210 and the inverter of the second pre-drive circuit 212 output the first control signal V_{c1} and the second control signal V_{c2} of high voltage level respectively, i.e. the first control signal V_{c1} is 1.5V and the second control signal V_{c2} is 0.75V. As the gate-source voltage drop of the N-type field effect transistor Mₙ₁ is 0.75V (i.e. larger than the threshold voltage Vth), the N-type field effect transistor Mₙ₁ will be turned on to consequently turn on the N-type field effect transistor Mₙ₂, then the second supply voltage V_{gnd} discharges the equivalent capacitor Cₒᵤₜ at the output terminal Nₒᵤₜ. The first control signal V_{c1} turns off the P-type field effect transistor Mₚ₁, so the output voltage Vₒᵤₜ will be discharged to the low voltage level 0V.

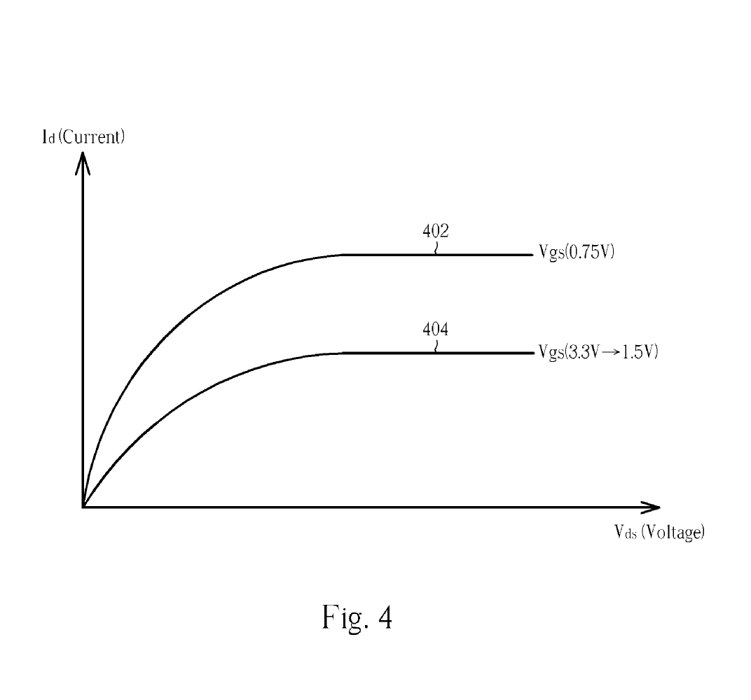

Please refer to FIG. 4. FIG. 4 is a current-voltage transfer characteristic diagram of the N-type field effect transistors Mₙ₁, Mₙ₂ as shown in FIG. 2. When the output voltage Vₒᵤₜ is decreased from 1.5V to 0V, the currents of the low voltage N-type field effect transistor Mₙ₁, Mₙ₂ are larger than the currents of the conventional high voltage (3.3V) N-type field effect transistors that operate under 1.5V, as shown in the curve 404 in FIG. 4. In other words, the current charging efficiency of the N-type field effect transistors Mₙ₁, Mₙ₂ is better than the conventional method.

Please note that, as the transistors of the embodiment output signal driving circuit 200 are low voltage field effect transistors fabricated by the ASIC foundry, only one manufacturing process has been utilized for reaching the requirements of low voltage specification, such as DDR1, DDR11, and DDR111 memory specification.

In addition, the above-mentioned embodiment output signal driving circuit 200 is described as applied in a DDR111 memory, however this is not a limitation of the present invention. In other words, the V_{dd} can be changed according to requirements, and the third, fourth, fifth, and sixth reference voltages V_{ref3}˜V_{ref6} can also be adjusted accordingly. Those skilled in this art will easily understand how to adjust the voltage level after reading the above-mentioned disclosed circuit as shown in FIG. 2, thus the detailed description is omitted here for brevity.

When the output terminal Nₒᵤₜ of the output signal driving circuit 200 receives an external voltage from a next stage circuit, the breakdown phenomenon will not happen to the P-type field effect transistor Mₚ₂ and the N-type field effect transistor Mₙ₂. For example, if V_{dd} is 1.5V and V_{ref} is 0.75V, and when the external voltage received by the output terminal Nₒᵤₜ is 1.5V or 0V, then the gate-source voltage drop of the P-type field effect transistor Mₚ₂ and the N-type field effect transistor Mₙ₂ will not be higher than 1.3V. Therefore, according to the above-mentioned operation, no matter whether the output terminal Nₒᵤₜ is in a charging situation, a discharging situation, or receiving the external voltage (e.g. coupled to the DDR1, DDR11, or DDR111 memory), the gate-source voltage drop of any field effect transistor in the embodiment is not higher than 1.3V, therefore the 1.3V P-type and N-type field effect transistors will not break down in this embodiment.

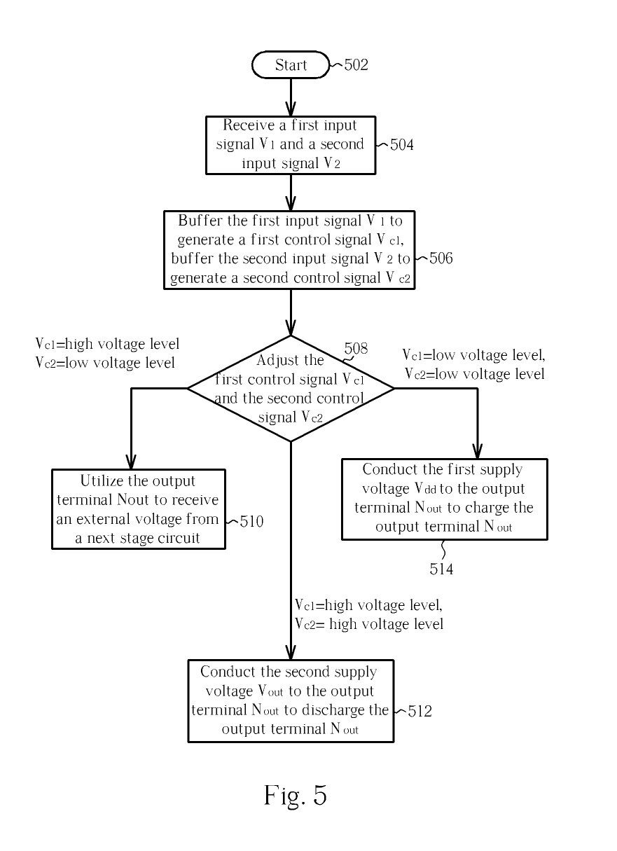

Please refer to FIG. 5. FIG. 5 is a flow chart illustrating an output signal driving method according to a second embodiment of the present invention. The output signal driving method includes the following steps:

Step 502: Start;

Step 504: Receive a first input signal V₁ and a second input signal V₂;

Step 506: Buffer the first input signal V₁ to generate a first control signal V_{c1}, buffer the second input signal V₂ to generate a second control signal V_{c2};

Step 508: Adjust the first control signal V_{c1} and the second control signal V_{c2}, if the first control signal V_{c1} is at the high voltage level, and the second control signal V_{c2} is at the low voltage level, then go to step 510; if the first control signal V_{c1} is at the high voltage level, and the second control signal V_{c2} is at the high voltage level, then go to step 512; if the first control signal V_{c1} is at the low voltage level, and the second control signal V_{c2} is at the low voltage level, then go to step 514;

Step 510: Utilize the output terminal Nₒᵤₜ to receive an external voltage from a next stage circuit;

Step 512: Conduct the second supply voltage Vₒᵤₜ to the output terminal Nₒᵤₜ to discharge the output terminal Nₒᵤₜ;

Step 514: Conduct the first supply voltage V_{dd} to the output terminal Nₒᵤₜ to charge the output terminal Nₒᵤₜ.

In step 504, the output signal driving method receives the first input signal V₁ and the second input signal V₂ at the same time. In step 506, the output signal driving method buffers the first input signal V₁ to generate the first control signal V_{c1} and buffer the second input signal V₂ to generate the second control signal V_{c2}. Then, the output signal is determined according to the voltage level (i.e. high voltage level or low voltage level) of the first control signal V_{c1} and the second control signal V_{c2} (step 508). According to the output signal driving circuit 200 of an embodiment, the high voltage level is V_{dd} and the low voltage level is V_{dd}/2.

Those skilled in the art will readily observe that numerous modifications and alterations of the device and method may be made while retaining the teachings of the invention.

What is claimed is:

1. An output signal driving circuit, comprising:
a first switch, having a terminal coupled to a first supply voltage, and having another terminal coupled to a first terminal, wherein the conductivity of the first switch is controlled by a first control signal for selectively conducting the first supply voltage to the first terminal;
a second switch, having a terminal coupled to a second supply voltage, and having another terminal coupled to a second terminal, wherein the conductivity of the second switch is controlled by a second control signal for selectively conducting the second supply voltage to the second terminal;
a third switch, having a terminal coupled to the first terminal, and having another terminal coupled to an output terminal, wherein the conductivity of the third switch is controlled by a third reference voltage for selectively conducting the first terminal to the output terminal; and
a fourth switch, having a terminal coupled to the output terminal, and having another terminal coupled to the second terminal, wherein the conductivity of the fourth switch is controlled by a fourth reference voltage for selectively conducting the output terminal to the second terminal;
wherein voltage levels of the third reference voltage and the fourth reference voltage are between the voltage level of the first supply voltage and the voltage level of the second supply voltage.

2. The output signal driving circuit of claim 1, further comprising:
a first pre-drive circuit, coupled to the first switch for receiving a first input signal, and selecting one of the first supply voltage and a fifth reference voltage to be the first control signal according to the first input signal; and
a second pre-drive circuit, coupled to the second switch for receiving a second input signal, and selecting one of the second supply voltage and a sixth reference voltage to be the second control signal according to the second input signal;
wherein voltage levels of the fifth reference voltage and the sixth reference voltage are between the voltage level of the first supply voltage and the voltage level of the second supply voltage.

3. The output signal driving circuit of claim 2, wherein the third reference voltage and the fourth reference voltage correspond to the same voltage level.

4. The output signal driving circuit of claim 2, wherein the fifth reference voltage and the sixth reference voltage correspond to the same voltage level.

5. The output signal driving circuit of claim 2, wherein the first pre-drive circuit is an inverter.

6. The output signal driving circuit of claim 2, wherein the second pre-drive circuit is an inverter.

7. The output signal driving circuit of claim 1, wherein the first switch, the second switch, the third switch, and the fourth switch are field effect transistors, and the gate terminals of the field effect transistors receive the first control signal, the second control signal, the third reference voltage, and the fourth reference voltage respectively.

8. The output signal driving circuit of claim 7, wherein both the first switch and the third switch are P-type field effect transistors, and both the second switch and the fourth switch are N-type field effect transistors.

9. The output signal driving circuit of claim 1, being installed within a memory.

10. The output signal driving circuit of claim 9, wherein the memory is a double data rate memory (DDR memory).

11. An output signal driving method, comprising:
selectively conducting the first supply voltage to the first terminal according to a first control signal;
selectively conducting the second supply voltage to the second terminal according to a second control signal;
selectively conducting the first terminal to the output terminal according to a third reference voltage; and
selectively conducting the output terminal to the second terminal according to a fourth reference voltage;
wherein voltage levels of the third reference voltage and the fourth reference voltage are between the voltage level of the first supply voltage and the voltage level of the second supply voltage.

12. The output signal driving method of claim 11, further comprising:
selecting one of the first supply voltage and a fifth reference voltage to be the first control signal according to a first input signal; and
selecting one of the second supply voltage and a sixth reference voltage to be the second control signal according to a second input signal;
wherein voltage levels of the fifth reference voltage and the sixth reference voltage are between the voltage level of the first supply voltage and the voltage level of the second supply voltage.

13. The output signal driving method of claim 12, wherein the third reference voltage and the fourth reference voltage correspond to the same voltage level.

14. The output signal driving method of claim 12, wherein the fifth reference voltage and the sixth reference voltage correspond to the same voltage level.

15. The output signal driving method of claim 11, being applied in an inverter.

16. The output signal driving method of claim 15, wherein the memory is a double data rate memory (DDR memory).
